(19) United States
(12) Patent Application Publication
(10) Pub. No.: US 2002/0041914 A1
(43) Pub. Date: Apr. 11, 2002

(54) INJECTION MOULDING TOOL

(76) Inventor: ERNST WAGNER, ROTHENBACH/ALLGAU (DE)

Correspondence Address: KATHERINE PROCTOR, BROWN MARTIN HALLER AND MCCLAIN LLP, 1660 UNION STREET, SAN DIEGO, CA, 92101

(21) Appl. No.: 09/318,986

(22) Filed: May 26, 1999

(30) Foreign Application Priority Data
May 30, 1998 (DE) 198 24 463.0

(51) Int. Cl. B29C 45/64

(52) U.S. Cl. 425/589

(57) ABSTRACT

The invention concerns an injection moulding tool which includes at least two mould halves and/or mould inserts which can be closed by a force acting from the outside.

The invention is distinguished in that in the injection moulding tool or portions thereof is arranged at least one cavity which can be pressurised by means of a suitable medium, in that at least a portion of the wall defining the cavity is constructed as a flexible sealing zone via which the pressure is transmitted directly or indirectly to a contour or division of the mould inserts or to a work piece.

The invention concerns an injection moulding tool according to the introductory part of patent claim 1.

In the case of nearly all parts which are manufactured or produced by humans or machines, there are deviations of dimensions, i.e. tolerances. These tolerances cause great problems in the further processing of parts which are to have injection moulding round them, in injection moulding technology. Some techniques for minimising these tolerances have been known up to now. These methods are however very costly and can hardly be carried out at all in practice.

Furthermore, in the further processing of elastomers and thermoplastics and thermosetting plastics in mould making, over and over again there are difficulties in creating divisions without lateral waste or junctions with the extruded material, with respect to wear phenomena as well.

It is therefore the object of the invention to develop an injection moulding tool in such a way that tolerances arising can be compensated or minimised cheaply and easily.

This object is achieved by the characterising features of patent claim 1.

The invention is based on the fact that in the injection moulding tool or portions thereof is arranged at least one cavity which can be pressurised by means of a suitable medium, and that at least a portion of the wall defining the cavity is constructed as a flexible sealing zone via which the pressure is transmitted directly or indirectly to a contour or division of the mould inserts or to a work piece.

These sealing zones are produced by making a special cavity which runs almost parallel to the contour or to the division, the cavities being arranged in one mould half and/or a mould or contour insert of the injection moulding tool.

By varying the wall thickness of the flexible sealing zones, the pressure distribution to individual regions of the sealing zones can be adjusted according to the requirements. By forming weak points or predetermined bend points, the thickness of the extent of the sealing zone can be adjusted as well.

Each cavity can have several flexible sealing zones, which can be done advantageously when injection moulding more elaborate profiles.

Preferably the cavity is however not pressurised to “activate” the flexible sealing zones until after the mould halves of the injection moulding tool are closed. It is however also provided that the cavity or the pressure medium contained in it can be subjected constantly to a given initial pressure.

In a preferred embodiment the pressure medium consists of spherical solid bodies which, depending on application, can consist of metal, glass or ceramic spheres. To prevent wear of the surfaces defining the cavity, these surfaces are at least partially hardened.

In an alternative embodiment the pressure medium consists of a hydraulic medium, e.g. hydraulic oil, which however must be highly temperature-resistant for the purposes mentioned.

The pressure is built up in the cavity by admission of the pressure medium by hydraulics, manually by spindle drives or electromechanically.

The internal pressure of the pressure medium can be measured by a pressure sensor. This allows regulation of the internal pressure and adaptation to the respective purpose.

Associated with the invention in particular is the advantage that wear at sealing edges can be reduced, wherein manufacturing tolerances on the tool can be compensated as well. Similarly tolerances of inserts around or on which something is to be injection-moulded can be compensated.

Due to the flexible sealing zones, in particular production of injection mouldings with little or no lateral waste is possible. Similarly the invention allows conditional compensation of extrusion tolerances (e.g. angular vulcanisation moulds).

By choice of materials and design of the geometry of the weak points or predetermined bend points or the wall thickness of the flexible sealing zones, the distribution of forces and the sealing region can be affected. Horizontal and vertical sealing surfaces in the free mould surface region can be sealed simultaneously.

Another basic advantage is that considerably higher costs are not incurred for manufacture of the tool.

Below, several practical examples of the invention are described in more detail with the aid of several drawings. Further characteristics and advantages of the invention are apparent from the drawings and the description thereof. They show:

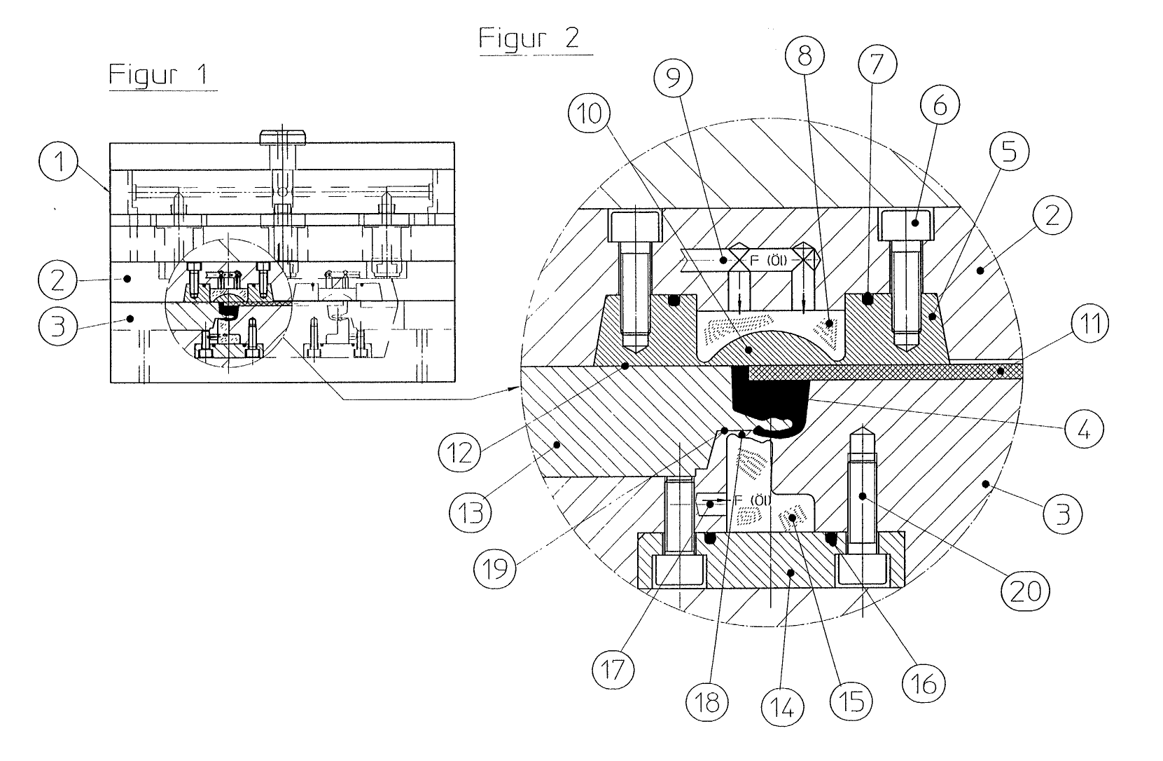

FIG. 1: a section through an injection moulding tool;

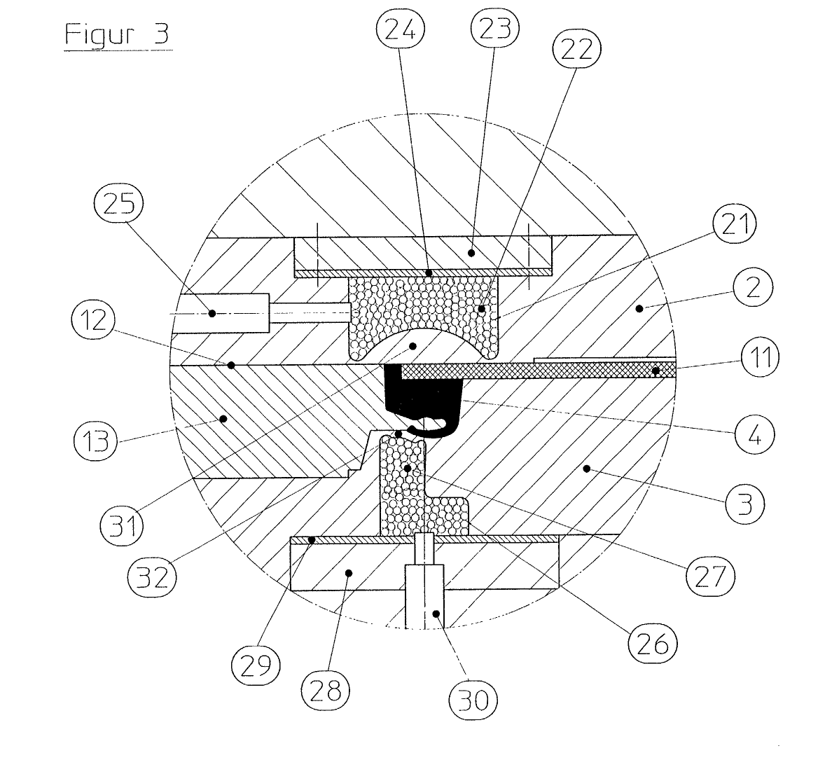

FIG. 2: an enlarged partial view of the injection moulding tool according to FIG. 1 with hydraulic fluid as the pressure medium;

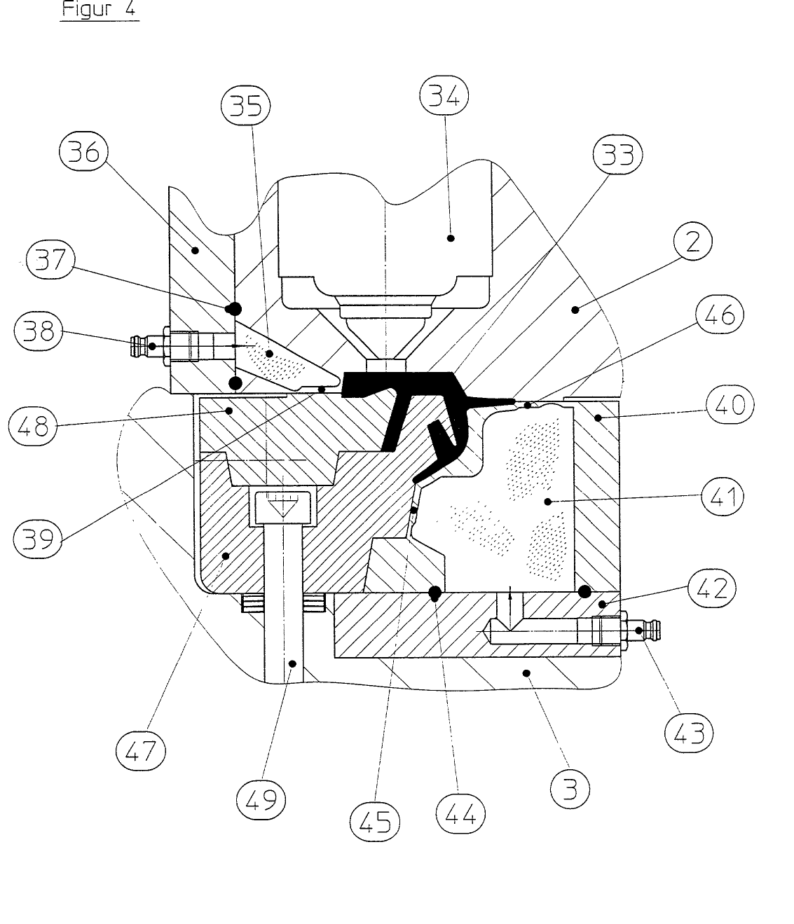

FIG. 3: a variant of the assembly according to FIG. 2 with spherical solid bodies as the pressure medium;

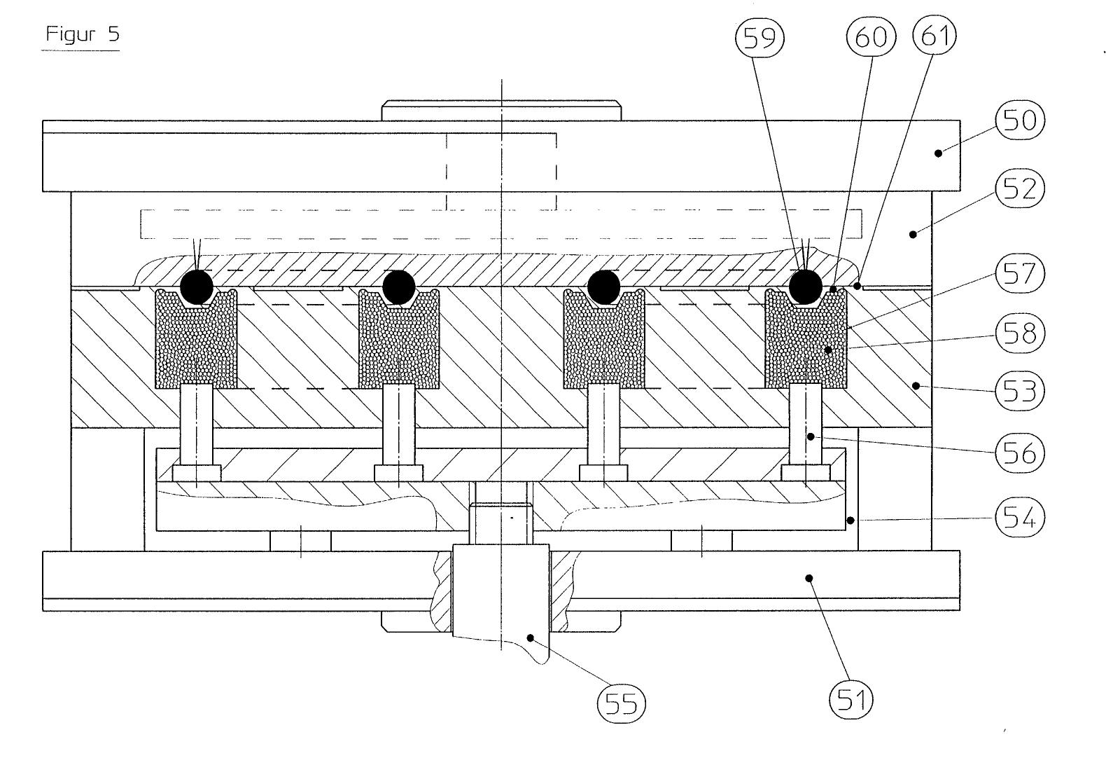

FIG. 4: another embodiment of an injection moulding tool with several cavities and sealing zones;

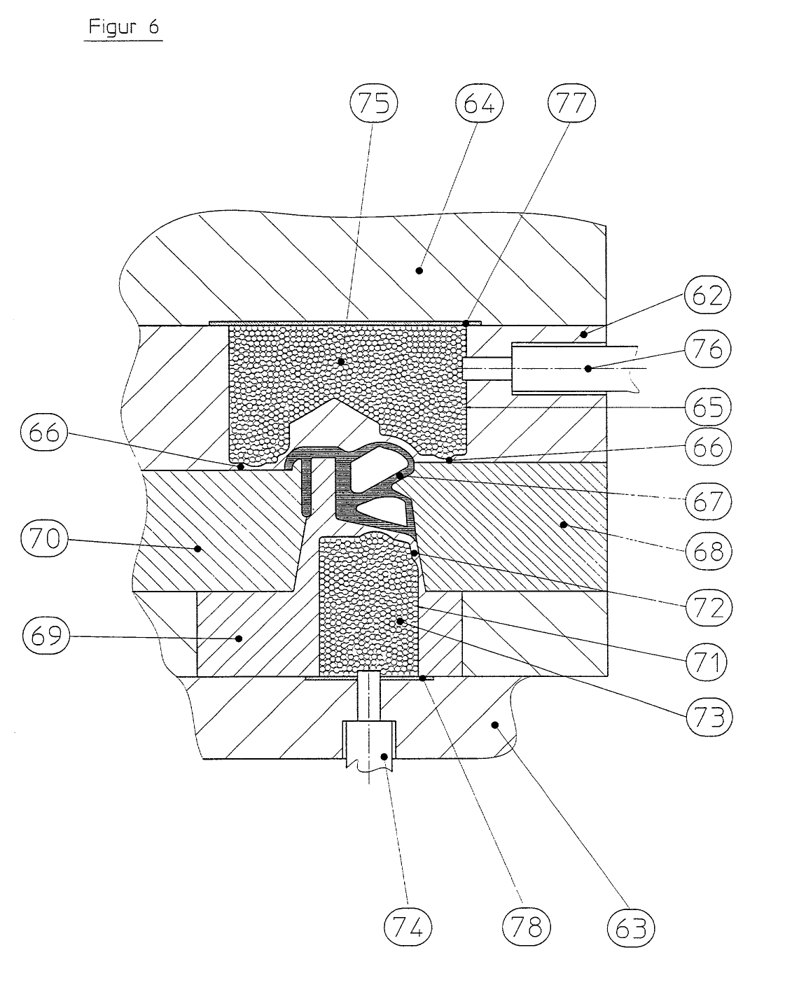

FIG. 5: a multiple injection moulding tool with spheres as the pressure medium;

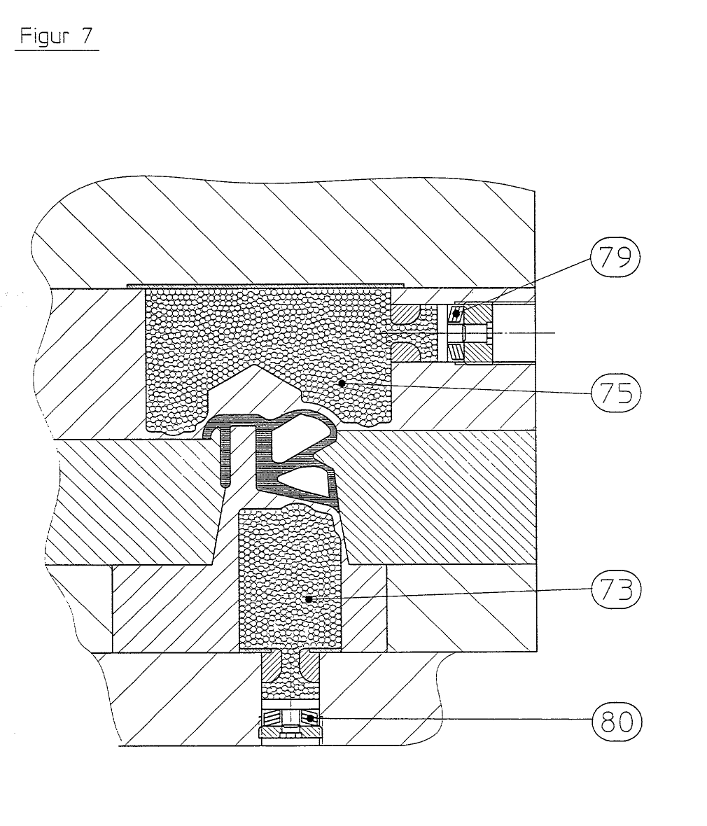

FIG. 6: another embodiment of an injection moulding tool with spheres as the pressure medium and initial hydraulic pressure;

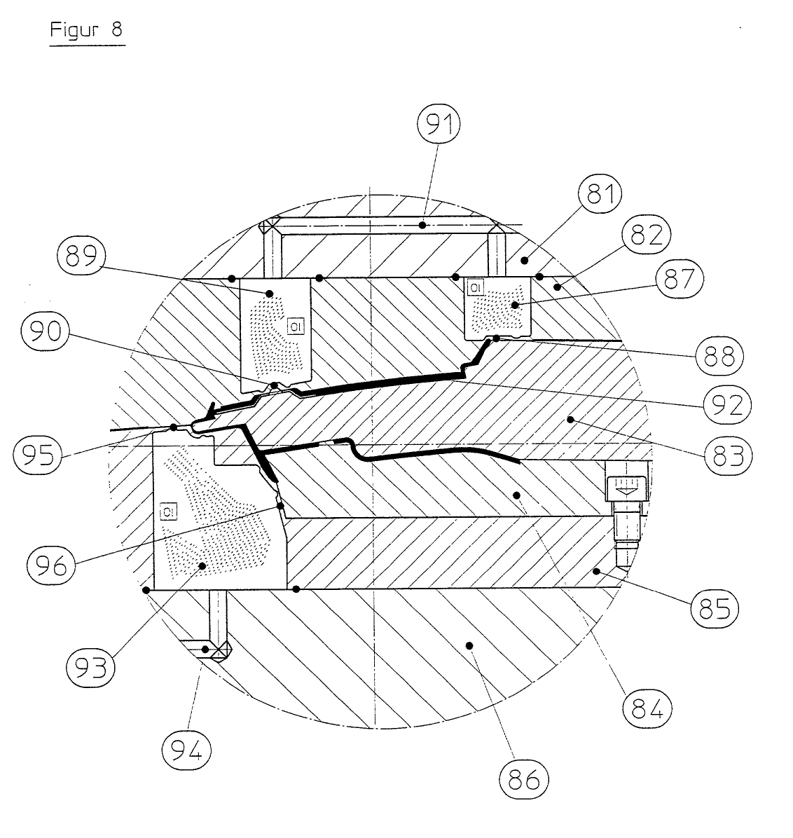

FIG. 7: an embodiment of an injection moulding tool with spheres as the pressure medium and initial pressure by spring force;

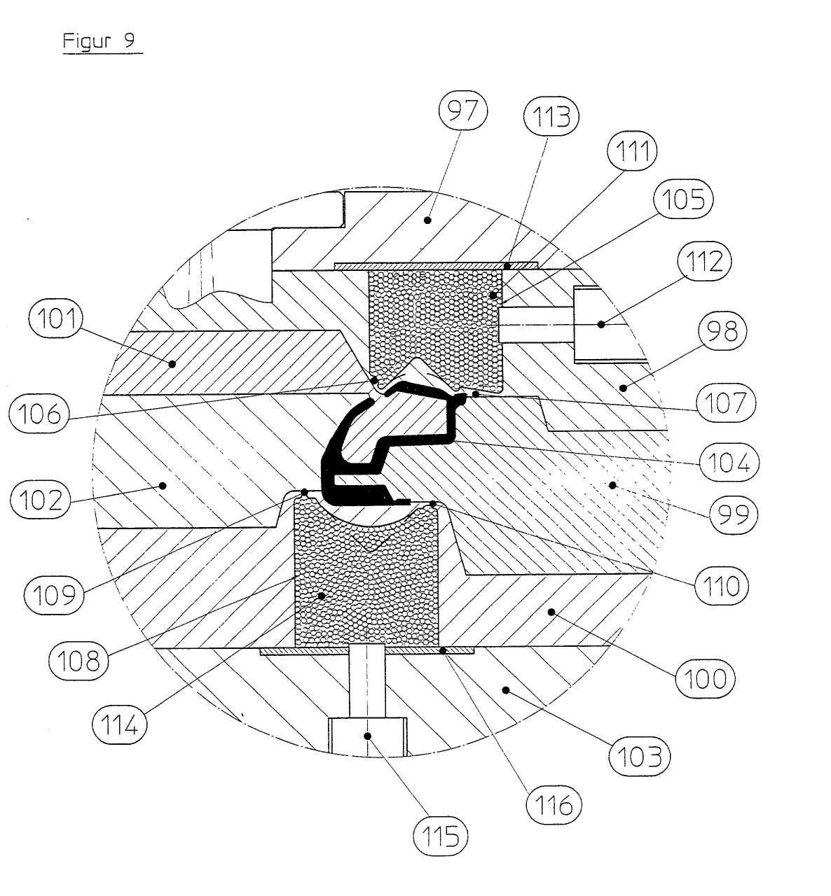

FIG. 8: another embodiment of an injection moulding tool with several cavities and sealing zones;

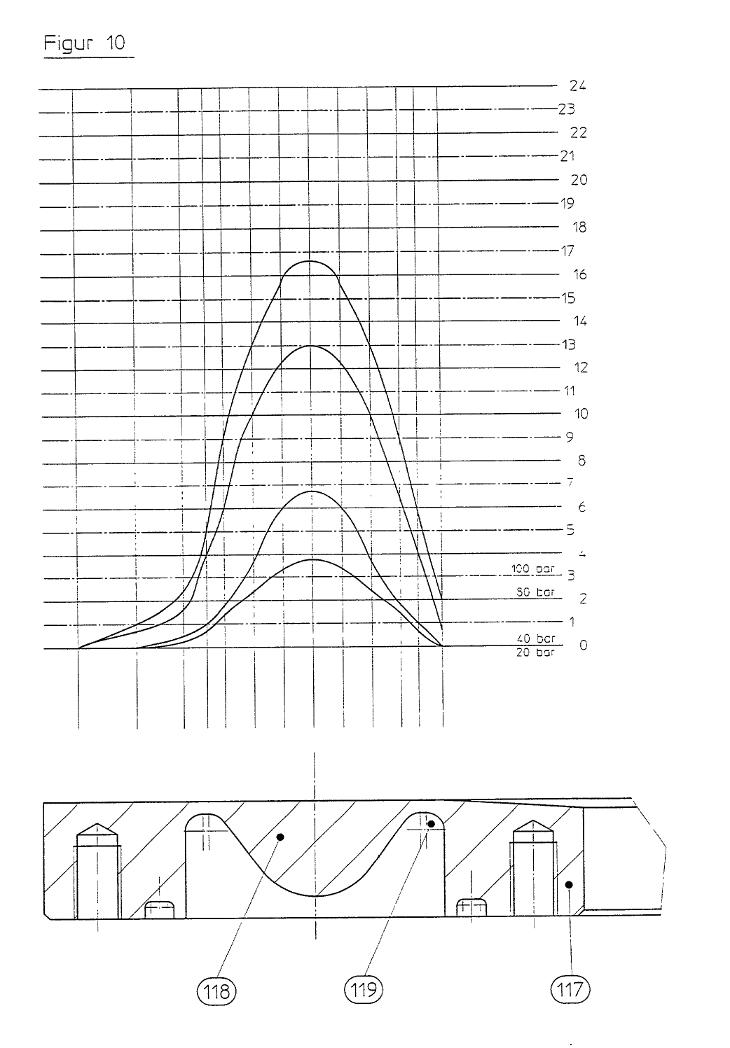

FIG. 9: another embodiment of an injection moulding tool with spherical solid bodies as the pressure medium;

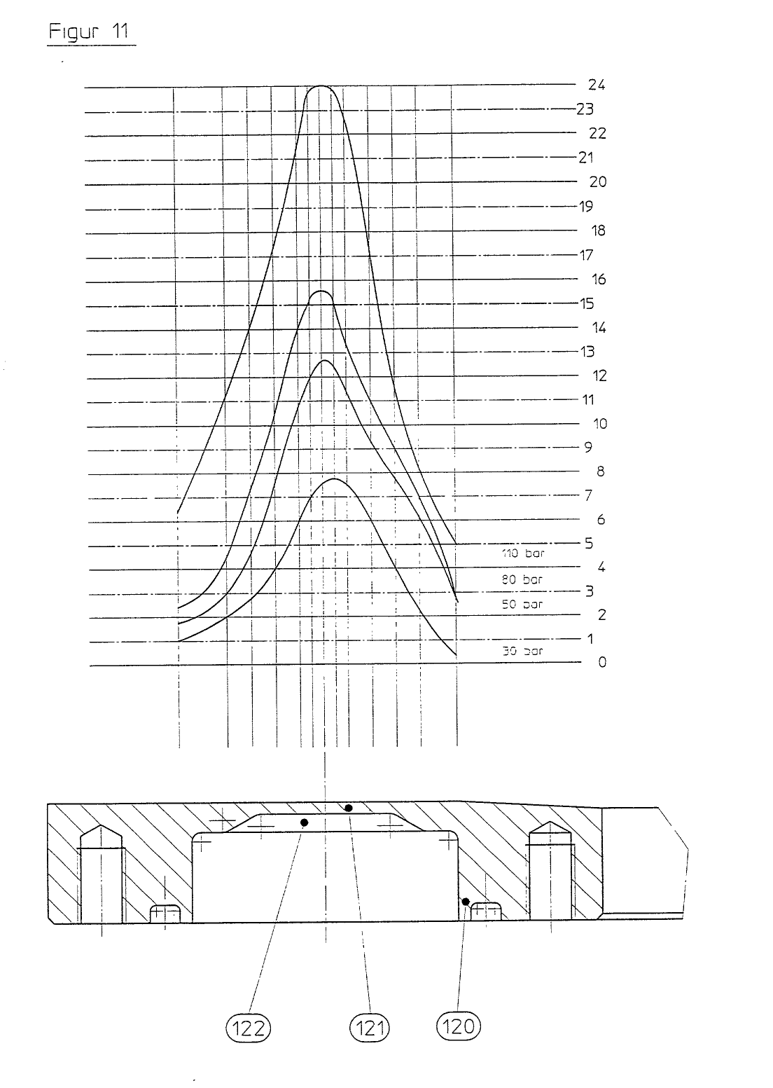

FIG. 10: example of construction of an insert with flexible sealing zone;

FIG. 11: example of construction of an insert with flexible sealing zone.

FIG. 1 shows, partly in section, an injection moulding tool according to the invention. This includes in a known manner an upper mould 2 and a lower mould 3 which in the closed state define a mould cavity for the manufacture of an injection moulding.

FIG. 2 shows an enlarged view of the region of the mould cavity from FIG. 1. Upper and lower moulds 2, 3 which meet along a dividing plane 12 can be seen. Between the mould halves 2, 3 is located an insert 11 which can be e.g. a plastic part. An injection moulding 4 in the form of a mould profile is to be injected onto this plastic part. The shape of the injection moulding is defined by the lower mould 3 and an insert 13. In the upper mould 2 is provided according to the invention an insert 5 which is joined to the upper mould with bolts 6. This insert 5 defines, together with the upper mould 2, a cavity 8 which can be filled with hydraulic fluid which is supplied via a supply pipe 9. To seal the cavity 8, seals 7 are provided between upper mould 2 and insert 5.

In the lower mould 3 is also arranged a cavity 15 which is closed by an insert 14 which is joined to the lower mould with bolts 20. Here too seals 16 are provided. This cavity can admit hydraulic fluid via a supply pipe 17.

When the work piece 11 is inserted and the mould halves 2, 3 are closed, according to the invention the cavities 8 and 15 are pressurised. Here the cavity 8 has a flexible sealing zone 10 which is in direct contact with the work piece 11 or the insert 13 and also partly seals off the mould cavity. Due to the build-up of pressure in the cavity 8, this flexible sealing zone expands in the direction of the work piece 11 or insert 13 and so seals the butt joints between insert 5, work piece 11 and insert 13.

Likewise the cavity 15 has a flexible sealing zone 18 which is in contact with the insert 13. This cavity 15 too is pressurised, so that the flexible sealing zone 18 expands in the direction of the insert 13 and presses together the dividing surfaces between sealing zone 18 and insert 13. The plastic can now be injected, in which process according to the invention a protruding seal is obtained by the flexible sealing zones 10, 18, considerably reducing or even completely preventing expulsion of the injection compound along the dividing gaps or planes 12 or 19. Furthermore use of the flexible sealing zones 10, 18 allows the compensation of tolerances of the injection moulding tool and reliable clamping of the work piece 11 in the region of injection moulding.

The injection moulding tool shown in FIG. 3 roughly corresponds in construction to FIGS. 1 and 2. Unlike the preceding example, however, the cavities 21 and 26 are filled with spherical solid bodies which form the pressure medium. Here cavity 21 is covered with a hardened steel plate 24 which is held by an insert 23. The cavity 27 is covered with a hardened steel plate 29 which is adjoined by an insert 28. The pressure builds up in the medium 22 via a hydraulic cylinder 25, and the pressure builds up in the pressure medium 27 likewise via a hydraulic cylinder 30. The pressure applied to the respective pressure medium 22, 27 spreads in an identical manner to the flexible sealing zones 31 and 32, whose function has already been described exactly above.

In another practical example of the injection moulding tool according to FIG. 4 again the upper and lower mould halves 2, 3 can be seen. The upper mould half 2 contains the injection nozzle 34. The lower mould half carries several inserts 40, 47 and 48 which, together with the upper mould, define the mould cavity for the injection moulding 33. The upper mould 2 has a cavity 35 which is filled with a hydraulic medium and can be pressurised via a supply pipe 38. The cavity 35 is covered with a plate 36 and sealed with seals 37. Adjoining the insert 48, the cavity 35 has a flexible sealing zone 39. If the cavity 35 is pressurised, the flexible sealing zone 39 expands in direction 48 and seals the adjoining dividing gap. The insert 40 also has a cavity 41 which can admit a pressure medium via a supply pipe 43. The cavity 41 is covered by a plate 42 and sealed with seals 44. Associated with the cavity 41 are two flexible sealing zones 45 and 46 which seal the region from the upper mould 2 and the insert 47 respectively. In the insert 47 is embedded a spring-loaded press pin 49 which presses the inserts 47 and 48 against each other and so ensures sealing of the dividing gap between them.

FIG. 5 shows a multiple injection moulding tool for the manufacture of O-rings 59 or the like. As the mould nests are of identical construction, only the right side of the drawing is described and can be transferred analogously to the left of the drawing. The injection moulding tool with upper and lower carrier plates 50, 51 and the mould plates 52 and 53 in between can be seen. The upper mould plate 52 contains in a known manner the injection unit. In the closed state a dividing plane 61 forms between the mould plates 52, 53, and the lower mould half 53 contains an annular cavity 57 which is filled with spherical solid bodies as a pressure medium. The cavity extends in each case just above the annular mould nests for the O-rings 59. Adjoining the inside and outside diameters of the O-rings 59 in the region of the dividing plane is in each case an annular flexible sealing zone 60. The lower carrier plate 51 includes an ejector unit 54 which can be pressurised via a hydraulic cylinder 55. This pressure is transmitted by press pins to the pressure medium 58 in the cavity 57. In the closed position of the injection moulding tool shown, the medium in the cavity 57 is pressurised, so that the flexible sealing zones 60 expand and ensure optimum sealing all round the injection moulding 59.

FIG. 6 shows an injection mould with a carrier plate 64 as well as an upper mould 62 and a lower mould 63. Several inserts 68, 69, 70 which define the mould cavity 67 for the injection moulding are provided. The upper mould has a cavity 65 which is filled with a pressure medium consisting of spherical solid bodies 75. With a pressure cylinder 76, pressure can be applied to this spherical solid body 75. The cavity 65 has two flexible sealing zones 56 which adjoin the inserts 68 and 70. The insert 69 also has a cavity 71 which is filled with spherical bodies 73. Here too pressure can be applied to the spherical bodies by means of a pressure cylinder 64. The cavity 71 has a flexible sealing zone 72 which adjoins the insert 68. The cavities 65 or 71 are covered with a hardened plate 77 or 78.

The view in FIG. 7 essentially corresponds to the embodiment according to FIG. 6, but here to apply pressure to the spherical bodies 73 or 75 there is used not a pressure cylinder, but in each case spring assemblies 79, 80 which produce the necessary initial pressure. In a known manner the initial pressure of the spring assemblies can be adjusted e.g. manually by an adjusting screw.

FIG. 8 shows an injection moulding tool consisting of upper and lower carrier plates 81 and 86 and several inserts 82, 83, 84 and 85 which define the mould cavity 92 for the injection moulding. In the inserts are provided several cavities 87, 89 and 93 which are each filled with a pressure medium which can be supplied via supply pipes 91 or 94. The cavity 87 here has a flexible sealing zone 88 which adjoins the insert 83. The cavity 89 has a flexible sealing zone 90 which also adjoins the insert 83. Cavity 93 has two flexible sealing zones 95 and 96 which adjoin the insert 82 or the insert 84.

The example according to FIG. 9 shows an injection moulding tool with carrier plates 97 and 103 and several inserts 98, 99, 100, 101 and 102 which define the mould cavity 104 for the injection moulding. The insert 98 has a cavity 105 which is filled with spherical bodies 111 to which pressure can be applied with a pressure cylinder 112. Flexible sealing zones 106, 107 are provided in each case, which adjoin the insert 99 or 101 and seal the dividing gap. The insert 100 also has a cavity 108 which is filled with spherical bodies 114. Here too the spherical bodies 114 can be subjected to pressure with a pressure cylinder 115. In order to protect the surfaces of the carrier plates 97 and 103 from the pressure medium, hardened plates 113 or 116 are provided.

FIG. 10 shows by way of example one possible way of constructing the flexible sealing zone. An insert 117 which forms the flexible sealing zone 118 is shown. Here at the respective edge of the flexible sealing zone 118 are provided predetermined bend points 119. These cause the pressure acting on the flexible sealing zone to increase relatively gently towards the middle of the flexible sealing zone.

FIG. 11 shows an insert 120 with a differently constructed flexible sealing zone 121 which has a weak point 122 in the middle region. Unlike the design according to FIG. 10, here a relatively high concentration of pressure can be observed in the region of the middle of the flexible sealing zone 121.

### Legend for Drawings

1 injection moulding tool

2 upper mould

3 lower mould

4 injection moulding

5 insert

6 bolt

7 seal

8 cavity

9 supply pipe

10 flexible sealing zone

11 work piece

12 dividing plane

13 insert

14 insert

15 cavity

16 seal

17 supply pipe

18 flexible sealing zone

19 dividing surface

20 bolt

21 cavity

22 spheres

23 insert

24 plate

25 hydraulic unit

26 cavity

27 spheres

28 insert

29 plate

30 hydraulic unit

31 flexible sealing zone

32 flexible sealing zone

33 injection moulding

34 injection nozzle

35 cavity

36 plate

37 seal

38 supply pipe

39 flexible sealing zone

40 insert

41 cavity

42 plate

43 supply pipe

44 seal

45 flexible sealing zone

46 flexible sealing zone

47 insert

48 insert

49 press pin

50 carrier plate

51 carrier plate

52 mould plate

53 mould plate

54 ejector unit

55 pressure cylinder

56 press pin

57 cavity

58 spheres

59 injection moulding

60 flexible sealing zone

61 dividing plane

62 upper mould

63 lower mould

64 carrier plate

65 cavity

66 flexible sealing zone

67 mould cavity

68 insert

69 insert

70 insert

71 cavity

72 flexible sealing zone

73 spheres

74 pressure cylinder

75 spheres

76 pressure cylinder

77 plate

78 plate

79 spring assembly

80 spring assembly

81 carrier plate

82 insert

83 insert

84 insert

85 insert

86 carrier plate

87 cavity

88 flexible sealing zone

89 cavity

90 flexible sealing zone

91 supply pipe

92 mould cavity

93 cavity

94 supply pipe

95 flexible sealing zone

96 flexible sealing zone

97 carrier plate

98 insert

99 insert

100 insert

101 insert

102 insert

103 carrier plate

104 mould cavity

105 cavity

106 flexible sealing zone

107 flexible sealing zone

108 cavity

109 flexible sealing zone

110 flexible sealing zone

111 spheres

112 hydraulic cylinder

113 plate

114 spheres

115 hydraulic cylinder

116 plate

117 insert

118 flexible sealing zone

119 predetermined bend point

120 insert

121 flexible sealing zone

122 weak point

1. Injection moulding tool with at least two mould halves and/or mould inserts which can be closed by a force acting from the outside, characterised in that in the injection moulding tool or portions thereof is arranged at least one cavity (8; 15) which can be pressurised by means of a suitable medium, in that at least a portion of the wall defining the cavity (8; 15) is constructed as a flexible sealing zone (10; 18) via which the pressure is transmitted directly or indirectly to a contour or division of the mould inserts (13) or to a work piece (11).

2. Injection moulding tool according to claim 1, characterised in that the cavity is arranged in one mould half (3) and/or a mould or contour insert (15) of the injection moulding tool.

3. Injection moulding tool according to either of claims 1 or 2, characterised in that the flexible sealing zone (10; 18) runs almost parallel to the contour or to the division (13) of the mould inserts.

4. Injection moulding tool according to any of claims 1 to 3, characterised in that the wall thickness of the flexible sealing zone (10; 18) varies.

5. Injection moulding tool according to any of claims 1 to 4, characterised in that the flexible sealing zone (10; 18) has weak points or predetermined bend points.

6. Injection moulding tool according to any of claims 1 to 5, characterised in that the cavity (41) has several flexible sealing zones (45; 46).

7. Injection moulding tool according to any of claims 1 to 6, characterised in that the cavity (8; 15; 41) is not pressurised until after the mould halves (2; 3) of the injection moulding tool are closed.

8. Injection moulding tool according to any of claims 1 to 7, characterised in that the pressure medium is a hydraulic medium.

9. Injection moulding tool according to any of claims 1 to 8, characterised in that the pressure medium consists of spherical solid bodies (22; 27).

10. Injection moulding tool according to any of claims 1 to 9, characterised in that the spherical solid bodies (22; 27) consist of metal, glass or ceramic.

11. Injection moulding tool according to any of claims 1 to 10, characterised in that the surfaces (24) defining the cavity (8; 15; 41) are at least partially hardened.

12. Injection moulding tool according to any of claims 1 to 11, characterised in that the pressure medium is pressurised hydraulically, manually or electromechanically.

13. Injection moulding tool according to any of claims 1 to 12, characterised in that the pressure in the pressure medium is measured with a suitable pressure sensor.
